(19) United States
(12) Patent Application Publication
(10) Pub. No.: US 2020/0271444 A1
(43) Pub. Date: Aug. 27, 2020

(54) VERIFICATION HUB AND VERIFICATION METHOD FOR MOTOR VEHICLE HUB RUNOUT TESTER

(71) Applicant: CITIC Dicastal CO., LTD., Qinhuangdao (CN)

(72) Inventors: Jinqi LYU, Qinhuangdao (CN); Zhigao YIN, Qinhuangdao (CN); Hanbao SUN, Qinhuangdao (CN)

(73) Assignee: CITIC Dicastal CO., LTD., Qinhuangdao (CN)

(21) Appl. No.: 16/552,396

(22) Filed: Aug. 27, 2019

(30) Foreign Application Priority Data
Feb. 27, 2019 (CN) 201910147036.5

(51) Int. Cl. G01B 21/26

(52) U.S. Cl. CPC G01B 21/26; G01B 2210/30; G01B 2210/12

(57) ABSTRACT

A verification hub for a motor vehicle hub runout tester includes an outer ring, an end plate and a clamping portion fixed to each other, and the clamping portion is detachably fixed to the end plate; the clamping portion includes a first positioning hole for positioning and clamping, and the cylindricity of the first positioning hole is smaller than a preset value; the outer circumference of the outer ring includes at least two turns of measuring cylindrical surfaces having preset axial lengths and buses parallel to an axis of the first positioning hole, the radial distances between the axes of the measuring cylindrical surfaces and the axis of the first positioning hole are greater than a preset value, and circular runout test values of the measuring cylindrical surfaces are preset first harmonic runout values.

### CROSS-REFERENCE TO RELATED APPLICATION

The present application claims benefit of Chinese Patent Application No. 201910147036.5, filed on Feb. 27, 2019, the contents of which are hereby incorporated by reference in their entirety.

### BACKGROUND

The motor vehicle hub (hereinafter referred to as the hub) is deformed during machining and heat treatment to cause a deviation in the shape of the hub. One of the common deviations is certain eccentric distance between the axis of rotation of the hub and the axis of the outer circumference of the hub. After the hub has the eccentric distance deviation, the outer circumference of the hub has a maximum runout value (peak value) and a minimum runout value (trough value) in one rotating circumference. Such circular runout having a peak value and a trough value in one rotating circumference is referred to as first harmonic runout in engineering, and the quality of the hub is evaluated based on this. If a motor vehicle is mounted with the hubs having too large first harmonic runout, the motor vehicle may bump or swing during driving, which is not safe and comfortable for a user. Thus, runout tests are required for ordinary hub products, and hub manufacturers are also equipped with motor vehicle hub runout testers special for testing motor vehicle hub runout.

The motor vehicle hub runout testers include contact and non-contact ones according to the test methods. The contact test principle indicates that a measuring component is used to be in contact with an inner or outer bead seat of a tested hub, and when the hub rotates, the runout of the inner or outer bead seat is transmitted to a displacement sensor through the measuring component, thereby realizing a hub runout test. The non-contact runout tester uses laser as a test source, the laser is directly projected onto an inner or outer bead seat of a tested hub, and the reflected light is tested to calculate the amount of runout when the hub rotates.

However, since all the hubs need to be tested, the test amount is relatively large. Either type of motor vehicle hub tester is gradually worn during use to lose the test accuracy. Accordingly, a standard hub (i.e., a defective product) having determined first harmonic runout values is required for verifying the accuracy and stability of first harmonic runout of the runout tester to ensure that the test data of the runout tester is accurate and reliable. At the same time, when test comparison is required for different hub runout testers, a standard hub having determined first harmonic runout values is also required to complete the comparison of first harmonic runout test results between different devices.

However, the verification directly using the real hub has the following problems:

1) Ordinary hubs are produced in mass with relatively stable quality, and it is difficult to find a hub having determined first harmonic runout values that are relatively large;

2) After the standard hub made of an ordinary hub is tested multiple times on the runout tester, the first harmonic runout value is easily changed due to wear, resulting in inaccurate verification;

3) The standard hub made of the ordinary hub is easily confused with the ordinary hub and flows into next procedure after verification, resulting in the loss of the standard hub and the introduction of defective products into the next procedure.

### SUMMARY

The present disclosure relates to a motor vehicle wheel manufacturing technology, in particular to a verification hub and verification method for a motor vehicle hub runout tester.

In view of this, the present disclosure is directed to provide a verification hub and verification method for a motor vehicle hub runout tester, which can accurately verify the runout tester, where the verification hub has a simple structure and a long service life, and is not confused with an ordinary motor vehicle hub.

In order to achieve the above objective, the technical solution of the present disclosure is implemented as follows:

A verification hub for a motor vehicle hub runout tester, including an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes at least two turns of measuring cylindrical surfaces having preset axial lengths and buses parallel to an axis of the first positioning hole, the radial distances between the axes of the measuring cylindrical surfaces and the axis of the first positioning hole are greater than a preset value, and circular runout test values of the measuring cylindrical surfaces are all preset first harmonic runout values.

In the above solution, the clamping portion further includes a boss assembled with the end plate, the end plate includes a second positioning hole matching the boss, and after the boss is mounted into the second positioning hole, the parallelisms between the buses of the measuring cylindrical surfaces and the axis of the first positioning hole are smaller than a preset value.

In the above solution, the two turns of measuring cylindrical surfaces are aligned at radial outer ends, and the radial dimension of the outer ring at the outer circumference between the two turns of measuring cylindrical surfaces is smaller than that of the measuring cylindrical surfaces.

In the above solution, the outer sides of the two turns of measuring cylindrical surfaces are respectively provided with a measuring vertical surface, and the angles between the measuring vertical surfaces and the measuring cylindrical surfaces are 80 to 90 degrees.

In the above solution, the clamping portion further includes an end face positioning surface matching the runout tester, the end face positioning surface is at one end of the clamping portion, and an angle of a preset size is formed between the end face positioning surface and the vertical plane of the axis of the first positioning hole.

In the above solution, the clamping portion further includes at least two threaded holes, the axes of the threaded holes are in the same direction as the axis of the first positioning hole, and the end plate further includes screw through holes matching the threaded holes; the clamping portion and the end plate are fixed as follows: after the boss is assembled with the second positioning hole, screws are inserted through the screw through holes and screwed into the threaded holes for fixing.

In the above solution, the end plate is provided with at least two lightening holes uniformly distributed along the circumference, and the radial distances between the lightening holes and the measuring cylindrical surface are greater than a preset value.

The present disclosure also provides a verification method for a motor vehicle hub runout tester, including:

clamping a verification hub meeting a preset requirement to a first runout tester for measurement verification to obtain verification data; and

when the verification data meets a preset requirement, determining that the measurement accuracy of the first runout tester meets a preset requirement, otherwise, determining that the measurement accuracy of the first runout tester does not meet the preset requirement.

In the above solution, clamping a verification hub meeting a preset requirement to a first runout tester for measurement verification to obtain verification data includes:

clamping the verification hub meeting a preset requirement to the first runout tester, and measuring, by the first runout tester, circular runout of preset portions of the verification hub in both the radial direction and the axial direction, where at least 64 points are measured in each direction; and then repeating the clamping at least three times, testing at each clamping, and performing preset analysis processing on test data to obtain the verification data.

In the above solution, before clamping a verification hub meeting a preset requirement to a first runout tester for measurement verification to obtain verification data, the method further includes:

clamping the verification hub to a second runout tester, and measuring, by the second runout tester, circular runout of the preset portions of the verification hub in both the radial direction and the axial direction, where 64 points are measured in each direction; repeating the measurement at least three times to obtain first circular runout values;

performing Fourier transform on the first circular runout values to obtain second circular runout values after clamping errors are removed from the verification hub;

performing preset statistical processing on the second circular runout values to obtain statistical data of fluctuation of the circular runout values of the verification hub in the radial direction and the axial direction; and

when the statistical data is in a preset range, determining that the verification hub meets the preset requirement.

According to the verification hub and verification method for a motor vehicle hub runout tester in the present disclosure, the verification hub includes an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes at least two turns of measuring cylindrical surfaces having preset axial lengths and buses parallel to an axis of the first positioning hole, the radial distances between the axes of the measuring cylindrical surfaces and the axis of the first positioning hole are greater than a preset value, and circular runout test values of the measuring cylindrical surfaces are all preset first harmonic runout values. Hence, the verification hub and verification method for a motor vehicle hub runout tester in the present disclosure can accurately verify the runout tester, and the verification hub has a simple structure and a long service life and is not confused with an ordinary motor vehicle hub.

Other advantageous effects of the present disclosure will be further described in conjunction with specific technical solutions in the specific embodiments.

### BRIEF DESCRIPTION OF DRAWINGS

FIG. 1 is a schematic diagram of a verification hub for a motor vehicle hub runout tester according to Embodiment 1 of the present disclosure;

FIG. 2 is a schematic diagram of FIG. 1 in A-A direction;

FIG. 3 is a schematic diagram of a clamping portion in the verification hub for a motor vehicle hub runout tester according to Embodiment 1 of the present disclosure;

FIG. 4 is a schematic diagram of a verification method for a motor vehicle hub runout tester according to Embodiment 2 of the present disclosure.

### DETAILED DESCRIPTION

It should be noted that, the terms “first\second\third” involved in the embodiments of the present disclosure are only intended to distinguish similar objects, but do not represent specific orders of the objects, and understandably, the “first\ second\third” may be interchanged in a specific order or consecutive.

Embodiments of the present disclosure provide a verification hub for a motor vehicle hub runout tester. The verification hub includes an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes at least two turns of measuring cylindrical surfaces having preset axial lengths and buses parallel to an axis of the first positioning hole, the radial distances between the axes of the measuring cylindrical surfaces and the axis of the first positioning hole are greater than a preset value, and circular runout test values of the measuring cylindrical surfaces are all preset first harmonic runout values.

The measuring cylindrical surfaces are surfaces for measuring circular runout; the verification hub is fixed to the motor vehicle hub runout tester through the first positioning hole, the motor vehicle hub runout tester is provided with a clamp including an expansion column, and the expansion column is inserted into the first positioning hole and then expands to clamp the verification hub.

The cylindricity of the first positioning hole is smaller than a preset value, so that the positioning is more accurate; the axial lengths of the measuring cylindrical surfaces are preset to facilitate the contact with measuring heads for measuring the circular runout; the circular runout test values of the measuring cylindrical surfaces are all preset first harmonic runout values, that is, the verification hub is a defective product, which is caused by the fact that the axes of the measuring cylindrical surfaces are inconsistent with the axes of rotation of the measuring cylindrical surfaces (because the axes of rotation are determined by the axis of the first positioning hole), that is, the verification hub simulates an unqualified hub of which the axis of the outer circumference is different from the axes of rotation, so that the motor vehicle hub runout tester can be verified; in practice, the motor vehicle hub is also designed with a mounting hole for mounting to an axle of a motor vehicle, and like the first positioning hole, the mounting hole also has the deviation of misalignment with the outer circumference of the hub, so the structural principle of the verification hub according to the embodiments of the present disclosure is identical to that of the real motor vehicle hub.

The verification hub for a motor vehicle hub runout tester according to the embodiments of the disclosure can accurately verify the runout tester, and the verification hub has a simple structure and a long service life, and is not confused with an ordinary motor vehicle hub.

The embodiments of the present disclosure also provide a verification method for a motor vehicle hub runout tester, including:

clamping a verification hub meeting a preset requirement to a first runout tester for measurement verification to obtain verification data; and

when the verification data meets a preset requirement, determining that the measurement accuracy of the first runout tester meets a preset requirement, otherwise, determining that the measurement accuracy of the first runout tester does not meet the preset requirement.

Here, the verification hub meeting a preset requirement indicates that the fluctuation of circular runout of the verification hub meets a preset requirement, specifically, the circular runout test values of the measuring cylindrical surfaces and the measuring vertical surfaces of the verification hub are preset first harmonic runout values, that is, the verification hub is a typical defective product; the first runout tester is a runout tester with unknown measurement accuracy, and the verification data meeting a preset requirement indicates that the fluctuation of circular runout of the verification hub tested by the runout tester with unknown measurement accuracy conforms to the actual fluctuation of circular runout of the verification hub.

In an embodiment, clamping a verification hub meeting a preset requirement to a first runout tester for measurement verification to obtain verification data includes:

clamping the verification hub meeting a preset requirement to the first runout tester, and measuring, by the first runout tester, circular runout of preset portions of the verification hub in both the radial direction and the axial direction, where at least 64 points are measured in each direction; and then repeating the clamping at least three times, testing at each clamping, and performing preset analysis processing on test data to obtain the verification data.

Here, the preset portions may be the measuring cylindrical surfaces and the measuring vertical surfaces, that is, the circular runout of the verification hub in both the radial direction and the axial direction may be simultaneously tested; at least 64 points measured in each direction are required for the calculation of a Fourier function, where the number of points is the N-th power of 2; the number of points is 64 or 128 for rough measurement, 512 for strict measurement, and 1024 or 2048 for stricter measurement. At least three times of clamping are repeated to avoid errors in the test, e.g., dust on the measuring heads, etc. The more times the test is, the more accurate the data is.

The preset analysis processing here includes both Fourier transform and statistical processing such as calculation of standard deviation.

By measurement after multiple times of clamping, not only the measurement accuracy of the first runout tester but also the clamping reliability of the second runout tester can be verified.

It is more scientific and accurate to obtain circular runout data of the verification hub through the Fourier function, so this embodiment is a preferred one. It can be understood that the verification data may also be obtained by selecting the measured portions and the measured points according to the requirements of other methods besides the Fourier function.

In an embodiment, before clamping a verification hub meeting a preset requirement to a first runout tester for measurement verification to obtain verification data, the method further includes:

clamping the verification hub to a second runout tester, and measuring, by the second runout tester, circular runout of the preset portions of the verification hub in both the radial direction and the axial direction, where 64 points are measured in each direction; repeating the measurement at least three times to obtain first circular runout values;

performing Fourier transform on the first circular runout values to obtain second circular runout values after clamping errors are removed from the verification hub;

performing preset statistical processing on the second circular runout values to obtain statistical data of fluctuation of the circular runout values of the verification hub in the radial direction and the axial direction; and

when the statistical data is in a preset range, determining that the verification hub meets the preset requirement.

Here, the statistical data is to test whether the verification hub meets the preset requirement, the second runout tester for measurement is a runout tester with known measurement accuracy, and the preset requirement indicates that the fluctuation of circular runout of the verification hub conforms to first harmonic runout, that is, the verification hub is a typical defective product.

The preset portions may be the measuring cylindrical surfaces and the measuring vertical surfaces, that is, the circular runout of the verification hub in both the radial direction and the axial direction may be simultaneously tested; the preset statistical processing is to calculate a standard deviation and the like for the obtained circular runout data, and a sine curve is drawn accordingly.

At least 64 points measured here are also required for the calculation of the Fourier function; at least three times of clamping are repeated to avoid the influence of clamping errors.

The present disclosure will be described in detail below with reference to the accompanying drawings and specific embodiments. It should be understood that the specific embodiments described herein are merely used for interpreting the present disclosure, rather than limiting the present disclosure.

### First Embodiment

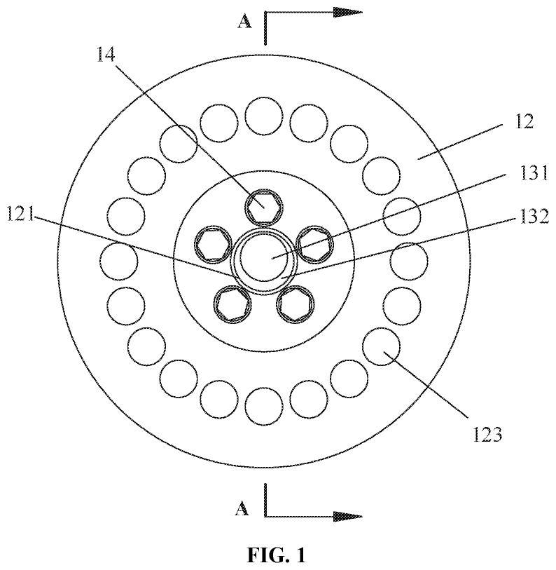

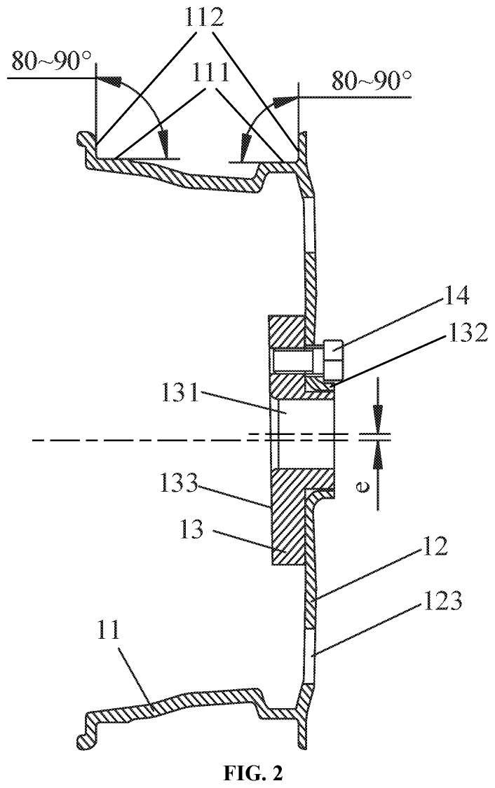

FIG. 1 is a schematic diagram of a verification hub for a motor vehicle hub runout tester according to an embodiment of the present disclosure, and FIG. 2 is a schematic diagram of FIG. 1 in A-A direction. As shown in FIG. 1 and FIG. 2, the verification hub for a motor vehicle hub runout tester includes an outer ring 11, an end plate 12 and a clamping portion 13 fixed to each other, the end plate 12 is at one end of the outer ring 11, and the clamping portion 13 is detachably fixed to the end plate 12; the clamping portion 13 includes a first positioning hole 131 for positioning and clamping, the first positioning hole 131 is a cylindrical hole, and the first positioning hole 131 is used for matching a clamp of the motor vehicle hub runout tester; the cylindricity of the first positioning hole 131 is smaller than a preset value to achieve accurate positioning; the outer circumference of the outer ring 11 includes at least two turns of measuring cylindrical surfaces 111 having preset axial lengths and buses parallel to an axis of the first positioning hole 131, the radial distances between the axes of the measuring cylindrical surfaces and the axis of the first positioning hole are e, and circular runout test values of the measuring cylindrical surfaces 111 are all preset first harmonic runout values; that is, the measuring cylindrical surfaces 111 are surfaces for measuring circular runout, the verification hub is a defective product, which is caused by the fact that the axes of the measuring cylindrical surfaces are inconsistent with the axes of rotation of the measuring cylindrical surfaces (because the axes of rotation are determined by the axis of the first positioning hole), that is, the verification hub simulates an unqualified hub of which the axis of the outer circumference is different from the axes of rotation, so that the motor vehicle hub runout tester can be verified.

Here, the value of e must be greater than a preset value. The preset value is to ensure a large enough difference between a peak value and a trough value of radial runout of the verification hub in a rotating circumference, so that the radial circular runout test values of the verification hub are preset first harmonic runout values to achieve the purpose of verifying the runout tester. In the embodiment, the value of e is preferably 1 to 2 mm.

In the embodiment, the clamping portion 13 further includes a boss 132 assembled with the end plate 12, the end plate 12 includes a second positioning hole 121 matching the boss 132, and after the boss 132 is mounted into the second positioning hole 121, the parallelism between the bus of the measuring cylindrical surface 111 and the axis of the first positioning hole 131 is smaller than a preset value, which puts forward requirements for the sizes, shapes and positions of the boss 132 and the second positioning hole 121. In this way, the clamping portion 13 and the end plate 12 are assembled more easily, and are positioned more accurately. The mounting portion 13 and the end plate 12 are mounted and fixed by hole shaft fit, which not only ensures the mounting accuracy (mainly positioning accuracy), but also simplifies the machining mode, so this embodiment is a preferred one.

In the embodiment, the two turns of measuring cylindrical surfaces 111 are aligned at radial outer ends, and the radial dimension of the outer ring 11 at the outer circumference between the two turns of measuring cylindrical surfaces 111 is smaller than that of the measuring cylindrical surfaces 111. The two turns of measuring cylindrical surfaces 111 are aligned at the radial outer ends, that is, the outer circumference is equal-height in the horizontal plane, which is convenient for measurement, that is, the circular runout measuring heads are easier to arrange. The radial dimension at the outer circumference between the two turns of measuring cylindrical surfaces 111 is smaller than that of the measuring cylindrical surfaces 111 for the purpose of yielding, i.e., avoiding the touch of the circular runout measuring heads to affect the measurement accuracy. Moreover, the accuracy and machining efficiency of the outer circumference of the two turns of measuring cylindrical surfaces 111 are ensured more easily.

In the embodiment, the outer sides of the two turns of measuring cylindrical surfaces 111 are respectively provided with a measuring vertical surface 112, and the angles between the measuring vertical surfaces 112 and the measuring cylindrical surfaces 111 are 80 to 90 degrees, which facilitates simultaneous placement of a radial measuring head for measuring radial circular runout and an axial measuring head for measuring axial circular runout, and improves the accuracy of test positioning. Thus, the axial circular runout can also be measured besides the radial circular runout, where the radial circular runout is outer circular runout of the outer circumference of the measuring cylindrical surfaces 111, and the axial circular runout is end face circular runout of the measuring vertical surfaces 112. It can be understood that only the outer circular runout may be measured.

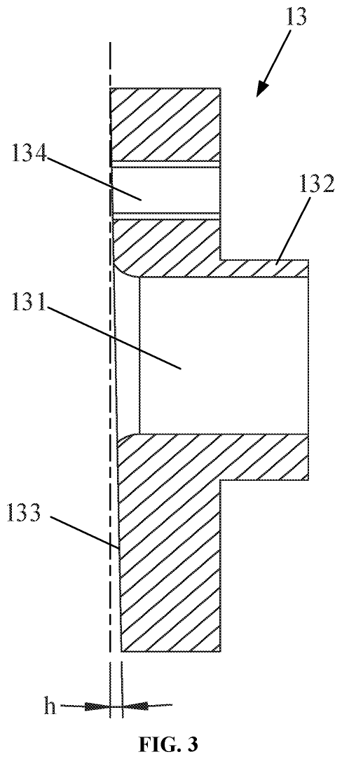

In the embodiment, as shown in FIG. 3, the clamping portion 13 further includes an end face positioning surface 133 matching the runout tester, the end face positioning surface 133 is at one end of the clamping portion 13, and an angle h is formed between the end face positioning surface 133 and the vertical plane of the axis of the first positioning hole 131. The end face positioning surface 133 is used for positioning the verification hub. In the presence of h, the mounting position of the verification hub is deviated, that is, the axial circular runout test values of the verification hub are preset first harmonic runout values. In addition, the value of h also needs to be large enough to ensure that the axial runout of the verification hub has a large enough difference between the peak value and the trough value in one rotating circumference, thereby achieving the purpose of verifying the runout tester. In the embodiment, the value of h may be 2 to 5 degrees.

In the embodiment, the clamping portion 13 further includes at least two threaded holes 134, the axes of the threaded holes 134 are in the same direction as the axis of the first positioning hole 131, and the end plate 12 further includes screw through holes matching the threaded holes 134; the clamping portion 13 and the end plate 12 are fixed as follows: after the boss 132 is assembled with the second positioning hole 121, screws 14 are inserted into the screw through holes and screwed into the threaded holes 134 for fixing. This is simple to fix and easy to assemble and disassemble. The numbers of the threaded holes 134 and the screw through holes In the embodiment are preferably five.

In the embodiment, the end plate 12 is provided with at least two lightening holes 123 uniformly distributed along the circumference, and the radial distances between the lightening holes 123 and the measuring cylindrical surfaces 111 are greater than a preset value to ensure the strength of the verification hub. In this way, the verification hub is prevented from being too heavy to increase the load of the motor vehicle hub runout tester, and the too heavy verification hub easily causes the clamp to loosen and deviate. The number of the lightening holes 123 In the embodiment is preferably 20.

### Second Embodiment

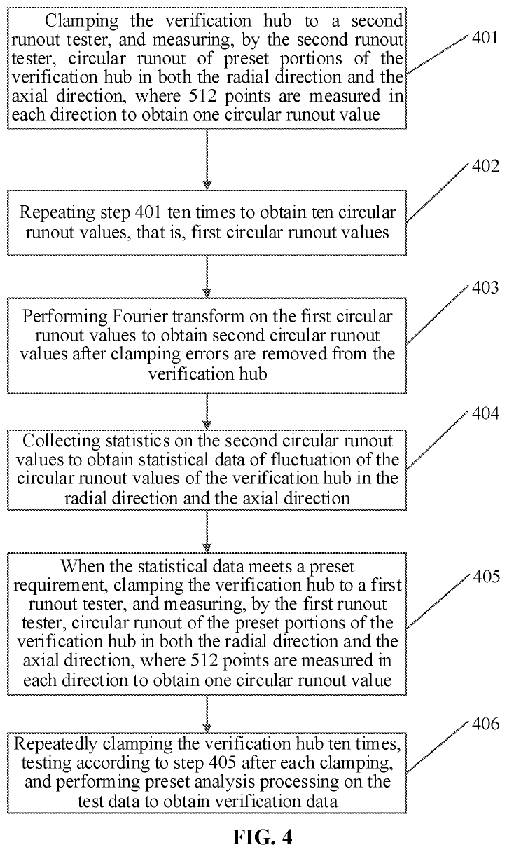

FIG. 4 is a schematic flowchart of a verification hub for a motor vehicle hub runout tester according to Embodiment 2 of the present disclosure. As shown in FIG. 4, the method includes the following steps:

In step 401: the verification hub is clamped to a second runout tester, and the second runout tester measures circular runout of preset portions of the verification hub in both the radial direction and the axial direction, where 512 points are measured in each direction to obtain one circular runout value; the preset portions here are the measuring cylindrical surfaces 111 and the measuring vertical surfaces 112;

In step 402: step 401 is repeated ten times to obtain ten circular runout values, that is, first circular runout values; because of many measurement points and multiple tests, more accurate test data can be obtained;

In step 403: Fourier transform is performed on the first circular runout values to obtain second circular runout values after clamping errors are removed from the verification hub; the clamping errors refer to errors caused by inaccurate positioning in clamping;

In step 404: statistics on the second circular runout values are collected to obtain statistical data of fluctuation of the circular runout values of the verification hub in the radial direction and the axial direction; specifically, the fluctuation is a sine curve, the specific analysis method is a runoff harmonic analysis method, which is a common method for analyzing circular runout of a motor vehicle hub, details are not described herein, and reference may be made to the paper “Research on Calibration Method for Aluminum Alloy Hub Runout Tester” in the Journal “Engineering and Testing” in 2013 Issue 04;

In step 405: when the statistical data meets a preset requirement, the verification hub is clamped to a first runout tester, and the first runout tester measures circular runout of the preset portions of the verification hub in both the radial direction and the axial direction, where 512 points are measured in each direction to obtain one circular runout value;

In step 406: the verification hub is repeatedly clamped ten times and tested according to step 405 after each clamping, and preset analysis processing is performed on the test data to obtain verification data; similar to step 404, the verification data also reflects the fluctuation of circular runout of the verification hub, and is a sine curve; here, the measurements after multiple times of clamping can verify the measurement accuracy of the first runout tester, and can also verify the clamping reliability of the first runout tester.

Through the above method, the verification hub can accurately verify the runout tester, has a simple structure and a long service life, and is not confused with an ordinary motor vehicle hub.

The foregoing descriptions are merely preferred embodiments of the present disclosure, but are not intended to limit the protection scope of the present disclosure. Any modifications, equivalent substitutions, improvements and the like made within the spirit and principle of the present disclosure shall fall within the protection scope of the present disclosure.

1. A verification hub for a motor vehicle hub runout tester, wherein the verification hub comprises an outer ring, an end plate and a clamping portion fixed to each other; the end plate is at one end of the outer ring, and the clamping portion is detachably fixed to the end plate; the clamping portion comprises a first positioning hole for positioning and clamping, the first positioning hole is a cylindrical hole, and the cylindricity of the first positioning hole is smaller than a preset value; the outer circumference of the outer ring comprises at least two turns of measuring cylindrical surfaces having preset axial lengths and buses parallel to an axis of the first positioning hole, the radial distances between the axes of the measuring cylindrical surfaces and the axis of the first positioning hole are greater than a preset value, and circular runout test values of the measuring cylindrical surfaces are all preset first harmonic runout values.

2. The verification hub for a motor vehicle hub runout tester according to claim 1, wherein the clamping portion further comprises a boss assembled with the end plate, the end plate comprises a second positioning hole matching the boss, and after the boss is mounted into the second positioning hole, the parallelisms between the buses of the measuring cylindrical surfaces and the axis of the first positioning hole are smaller than a preset value.

3. The verification hub for a motor vehicle hub runout tester according to claim 2, wherein the two turns of measuring cylindrical surfaces are aligned at radial outer ends, and the radial dimension of the outer ring at the outer circumference between the two turns of measuring cylindrical surfaces is smaller than that of the measuring cylindrical surfaces.

4. The verification hub for a motor vehicle hub runout tester according to claim 3, wherein the outer sides of the two turns of measuring cylindrical surfaces are respectively provided with a measuring vertical surface, and the angles between the measuring vertical surfaces and the measuring cylindrical surfaces are 80 to 90 degrees.

5. The verification hub for a motor vehicle hub runout tester according to claim 4, wherein the clamping portion further comprises an end face positioning surface matching the runout tester, the end face positioning surface is at one end of the clamping portion, and an angle of a preset size is formed between the end face positioning surface and the vertical plane of the axis of the first positioning hole.

6. The verification hub for a motor vehicle hub runout tester according to claim 5, wherein the clamping portion further comprises at least two threaded holes, the axes of the threaded holes are in the same direction as the axis of the first positioning hole, and the end plate further comprises screw through holes matching the threaded holes; the clamping portion and the end plate are fixed as follows: after the boss is assembled with the second positioning hole, screws are inserted through the screw through holes and screwed into the threaded holes for fixing.

7. The verification hub for a motor vehicle hub runout tester according to claim 6, wherein the end plate is provided with at least two lightening holes uniformly distributed along the circumference, and the radial distances between the lightening holes and the measuring cylindrical surface are greater than a preset value.

8. A verification method for a motor vehicle hub runout tester, wherein the method comprises:
clamping a verification hub meeting a preset requirement to a first runout tester for measurement verification to obtain verification data; and
when the verification data meets a preset requirement, determining that the measurement accuracy of the first runout tester meets a preset requirement, otherwise, determining that the measurement accuracy of the first runout tester does not meet the preset requirement.

9. The method according to claim 8, wherein clamping a verification hub meeting a preset requirement to a first runout tester for measurement verification to obtain verification data comprises:
clamping the verification hub meeting a preset requirement to the first runout tester, and measuring, by the first runout tester, circular runout of preset portions of the verification hub in both the radial direction and the axial direction, where at least 64 points are measured in each direction; and then repeating the clamping at least three times, testing at each clamping, and performing preset analysis processing on test data to obtain the verification data.

10. The method according to claim 9, wherein before clamping a verification hub meeting a preset requirement to a first runout tester for measurement verification to obtain verification data, the method further comprises:
clamping the verification hub to a second runout tester, and measuring, by the second runout tester, circular runout of the preset portions of the verification hub in both the radial direction and the axial direction, where 64 points are measured in each direction; repeating the measurement at least three times to obtain first circular runout values;
performing Fourier transform on the first circular runout values to obtain second circular runout values after clamping errors are removed from the verification hub;
performing preset statistical processing on the second circular runout values to obtain statistical data of fluctuation of the circular runout values of the verification hub in the radial direction and the axial direction; and
when the statistical data is in a preset range, determining that the verification hub meets the preset requirement.
